(19) United States
(12) Patent Application Publication
(10) Pub. No.: US 2016/0037968 A1
(43) Pub. Date: Feb. 11, 2016

(54) COOKING APPARATUS

(71) Applicant: MA. GUADALUPE ZUÑIGA MERAZ, COL. VALLE ALTO REYNOSA (MX)

(72) Inventor: MA. GUADALUPE ZUÑIGA MERAZ, COL. VALLE ALTO REYNOSA (MX)

(21) Appl. No.: 14/820,846

(22) Filed: Aug. 7, 2015

(30) Foreign Application Priority Data
Aug. 8, 2014 (MX) MX/U/2014/00396

(51) Int. Cl. A47J 37/06

(52) U.S. Cl. CPC A47J 37/0611

(57) ABSTRACT

A cooking apparatus, comprising a first cover and a second cover, each with heating elements and hinged together to contact each other, wherein each of the covers includes a plate having at least one cavity in a substantially hemispherical shape to receive a food product for cooking, the at least one cavity in a substantially hemispherical shape in the first plate matches the at least one cavity of the second plate to contact both covers; the heating element of each cover is arranged such that the heating element is in contact with substantially a center of the at least one substantially cavity in a substantially hemispherical shape.

### FIELD OF THE DISCLOSURE

This invention relates to an apparatus for cooking food products and specifically cooking appliances that use electric heating elements with non-stick cooking surfaces.

### BACKGROUND OF THE DISCLOSURE

There are in the state of the art different devices for cooking various food products, for example, hot-cakes, waffles, pastries, sandwiches, etc.

Appliances to make waffles are well known and comprise two metal plates with heating elements, the plates being hinged together and structured to touch each other when closed. The two plates or cooking surfaces reduce the cooking time and help to form the texture and finishing of the product. An apparatus of this type is shown in U.S. Pat. No. 8,327,757.

The cooking apparatus devices of the prior art are manufactured for the specific food product for cooking, and the shape of the heating plates varies according to such foodstuff.

One of the many ways to prepare dough products in Mexico is the “gordita” which is simply a variation of the pancake. It is very likely that these thick cakes were consumed before the arrival of Columbus. The gorditas are usually a specialty of northern of Mexico, but are consumed throughout the country.

In Mexico, Gorditas corn dough products are consumed in large volumes. For manufacturing, some people heat their corn dough mass on a dry griddle until it swells, and then fill it; others start with preparing the cake dough and then transfer the cake dough to boiling oil. Subsequently the cooked dough is divided and filled with pork, spicy sausage or cheese and chili.

The known traditional way of making gorditas is manual and has the following disadvantages: (1) Slow, (2) Poor quality, (3) No control inputs, (4) Lack of hygiene, and (5) Insecurity.

The apparatus of the present disclosure solves problems of devices in the manufacture of different Mexican gorditas of the prior art, problems being to attain improved efficiency, quality, economy, health and safety.

The devices of the present disclosure improve: (a) speed and efficiency by eliminating manual manufacturing of gorditas one by one; (b) quality by making gorditas of uniform size and desired cooking; (c) economy by having a uniform diameter and thickness, one can keep better control of inputs for manufacturing; (d) hygiene by being without manual contact with manufacturing it is possible to help to maintain cleanliness and hygiene during processing; (e) security in that the present disclosure avoids the big drawback of using butane and propane gas fuel, liquefied oil and natural gas (fuels that generate less waste than others), the use of which requires great care, correct handling and proper use within the regulations, since any gas leak can cause an explosion endangering the lives of the occupants of the house and other surrounding areas.

The present disclosure overcomes the security risks of using other fuels, inasmuch as the present disclosure generates its cooking heat based on electricity, since the present cooking apparatus operates based on electrical resistance with temperature rotary control providing the required cooking time by a clock with bell to indicate cooking completion. This is accomplished in compliance with scientifically and technologically required care for the environment and health.

The apparatus of the present disclosure is formed based on electrical resistors, used to manufacture Mexican gorditas, which is accomplished quickly (typically 6 minutes approximately) The apparatus comprises two covers, an upper cover and a lower cover, containing two plates (one in each cover), each plate featuring round molds in the which the raw material is placed in the center thereof. By closing both plates, the gordita is shaped, the device obtaining uniform and precise cooking, because a heating element passes under each mold and electrical resistance generates the cooking energy. The device has a clock with bell ringing alert, indicating the time and the end of cooking. Thus the disclosure provides an efficient system that provides quality, economy, health and safety in making gorditas.

When compared to gorditas prepared according traditional handmade approaches, the present disclosure provides the benefits of speed of production, cooking quality, size, economy without wasting supplies, hygiene and cleanliness, but especially safety at home, as well as lightness in weight, easy handling and easy transportation.

The device of the present disclosure is versatile and is suitable for using to cook beef, potatoes (with cheese, tuna, salmon, etc.), fat free products and also flour products.

The apparatus inside contains two plates with round molds, in which the raw material is placed in the center of the apparatus and by closing two plates boards the gordita is shaped, separation, distance and path of the electric heaters below each mold makes the cooking uniform, by achieving more cooking on both sides of the gordita, by causing the gordita to remain softer in the middle and spongy, to allow opening into two parts in order to introduce foods to fill the gordita.

The amount of gorditas by mold provides the user with the opportunity to decide among purchase options, according to the needs of the user.

This present disclosure provides a cooking apparatus, comprising a first cover and a second cover with heating elements and the covers being hinged together to contact each other, wherein each of the covers includes a plate having at least one cavity in a substantially hemispherical shape to receive a food product for cooking, wherein the at least one cavity in a substantially hemispherical shape in the first plate matches the at least one cavity of the second plate to contact both covers; the heating element of each cover is arranged such that said heating element is in contact with substantially a center of the at least one cavity in a substantially hemispherical shape.

### BRIEF DESCRIPTION OF THE DRAWINGS

In order to provide a better understanding of the present disclosure, a detailed description thereof is provided, along with the accompanying, drawings in which:

FIG. 1 is an elevation view of a cooking apparatus in accordance with the present disclosure, shown in a closed position;

FIG. 2 is a top plan view of a first embodiment of the apparatus of FIG. 1, with the covers shown in an open position;

FIG. 3 is a bottom plan view of the apparatus of FIG. 2, with the covers broken away in order to show the heating elements;

FIG. 4 is a top plan view of a second embodiment of the cooking apparatus of FIG. 1, with covers shown in an open position;

FIG. 5 is a bottom plan view of the apparatus of FIG. 4, with the covers removed in order to show the heating elements;

FIG. 6 is an elevation view of a further embodiment of the cooking apparatus in accordance with the present disclosure, shown in a closed position;

FIG. 7 is a top plan view of a first embodiment of the cooking appliance of FIG. 6, with covers shown in an open position;

FIG. 8 is a bottom plan view of the apparatus of FIG. 7, with covers removed in order to show the heating elements;

FIG. 9 is a top plan view of a second embodiment of the cooking appliance of FIG. 6, with the covers shown in an open position; and

FIG. 10 is a bottom view of the apparatus of FIG. 9, without covers removed in order to show the heating elements.

### DETAILED DESCRIPTION

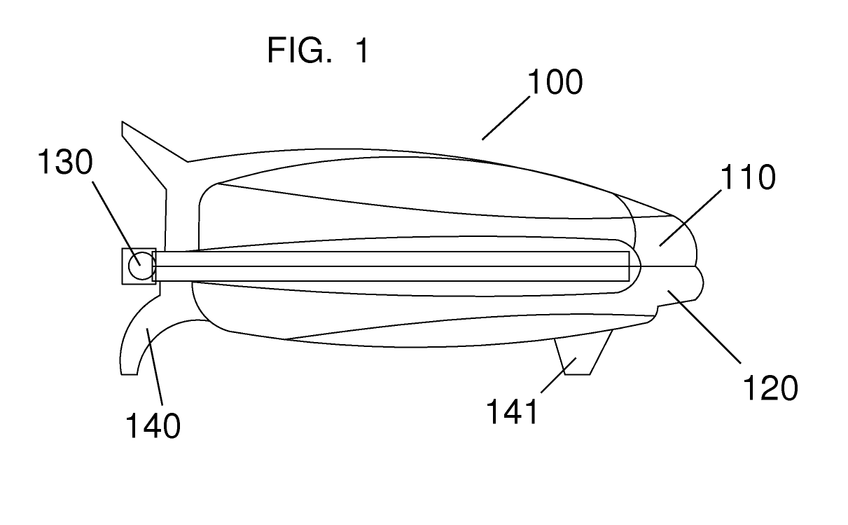

Referring to FIG. 1 through FIG. 6, a cooking apparatus 100 comprises a first cover 110 and second cover 120 which covers are hinged together by a hinge element 130. Likewise, the cooking apparatus 100 is supported by legs 140 and 141.

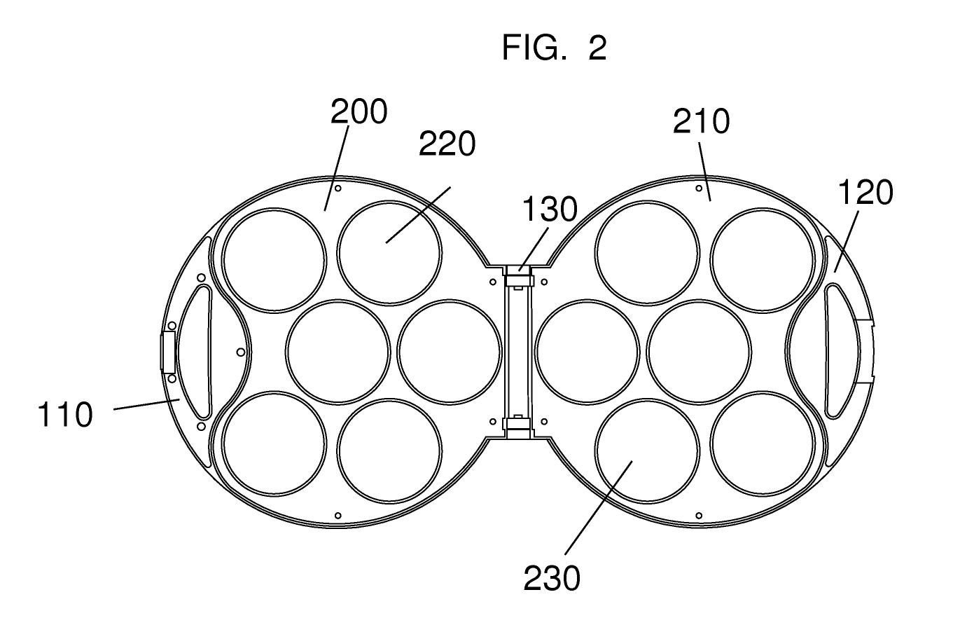

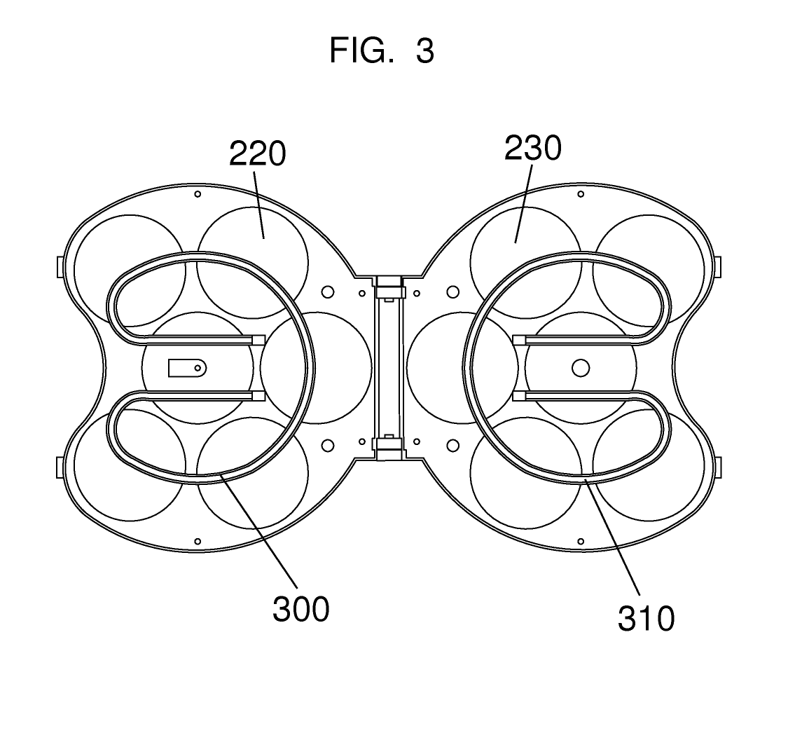

The covers 110 and 120 have inside plates 200 and 210, respectively, which in turn present several cavities in a substantially hemispherical shape 220 and 230. The cooking apparatus in this embodiment includes six cavities in each plate, as illustrated in FIG. 2 and FIG. 3. Also, heating elements 300 and 310 are located behind each plate as seen in FIG. 3.

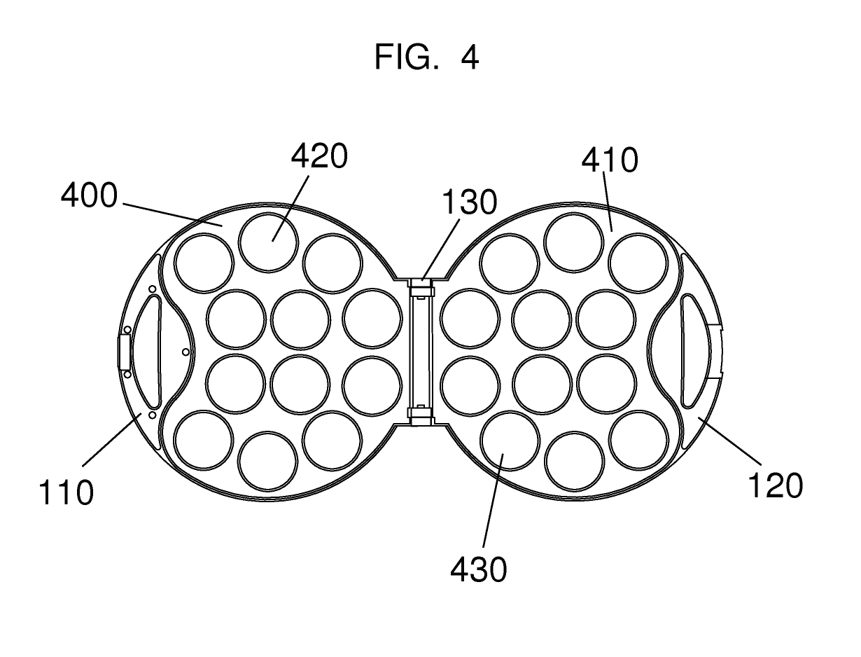

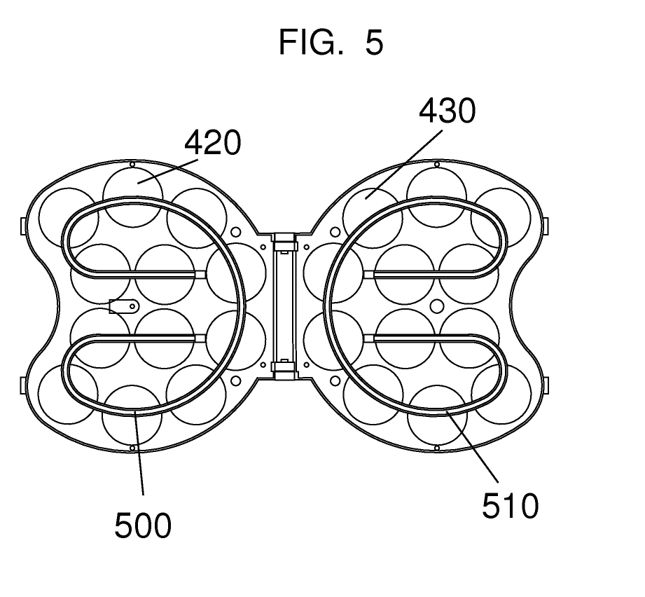

In one embodiment in the cooking apparatus 100, the covers 110 and 120 have plates 400 and 410 which in turn present several cavities in a substantially hemispherical shape 420 and 430. The cooking apparatus in this embodiment includes twelve cavities in each plate, as illustrated in FIG. 4 and FIG. 5. Also heating elements are located behind each plate 500 and 510 as seen in FIG. 5.

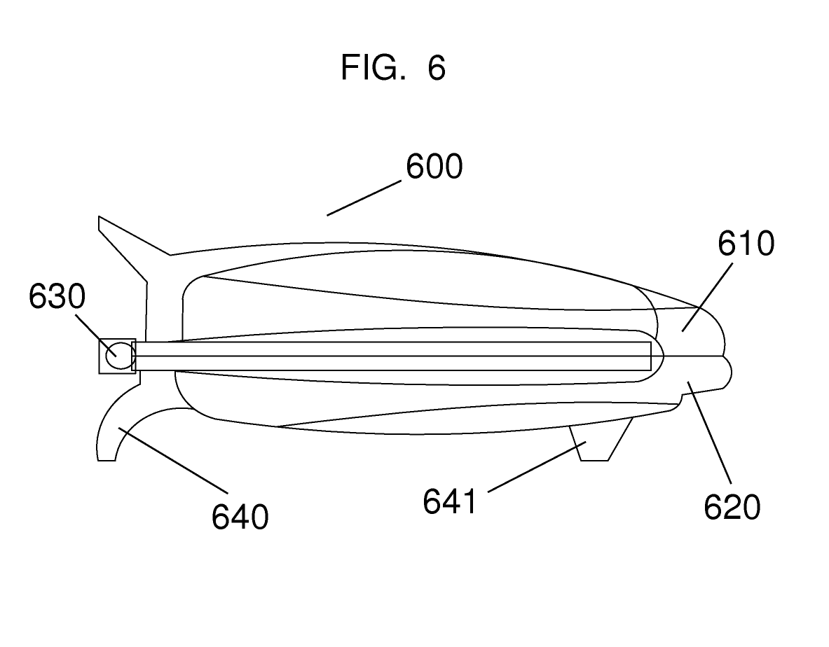

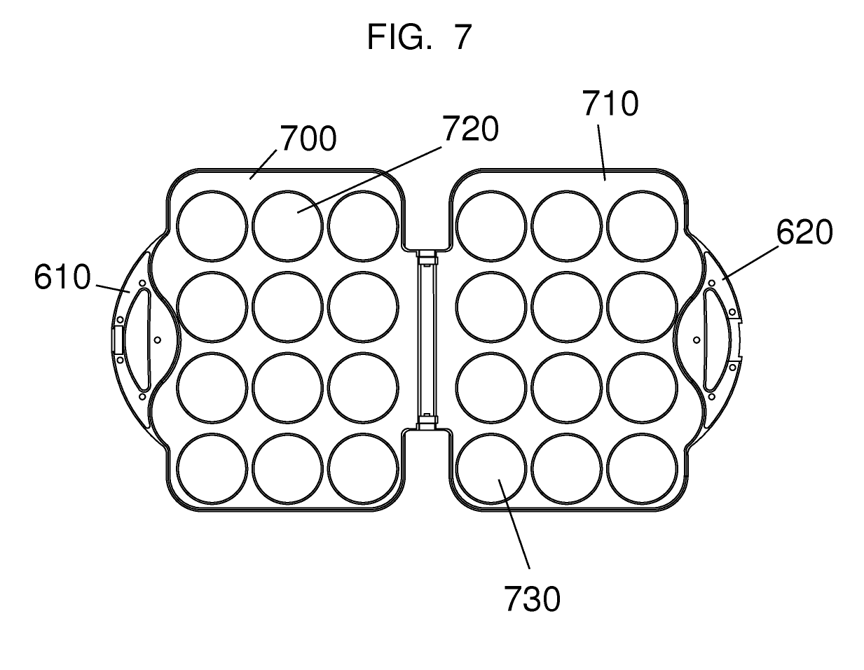

Referring to FIG. 6 through FIG. 10, a cooking apparatus 600 comprises a first cover 610 and second cover 620 which covers are hinged together by a hinge element 630. Likewise, the cooking apparatus 600 is supported by legs 640 and 641.

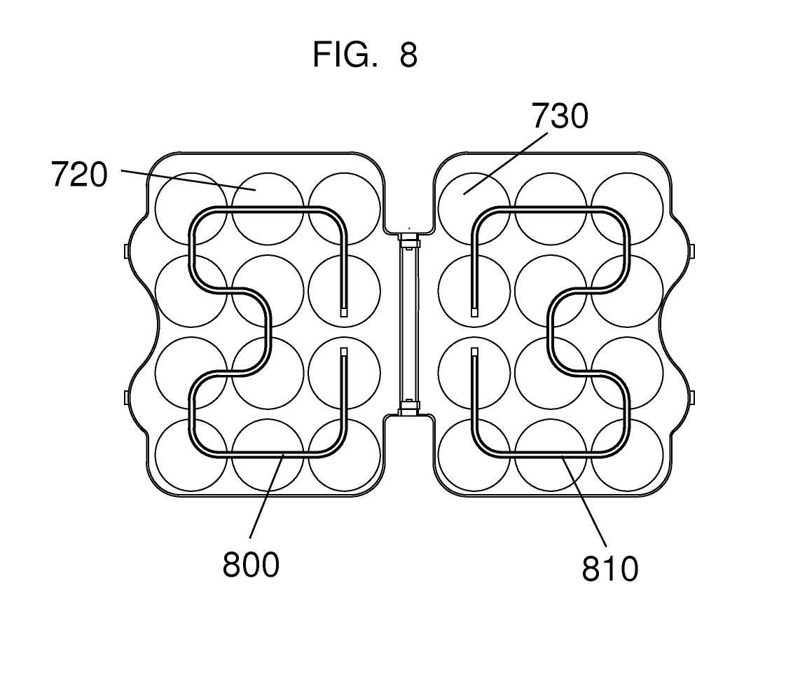

The covers 610 and 620 have inside plates 700 and 710, respectively, which in turn present several cavities in a substantially hemispherical shape 720 and 730. The cooking apparatus in this embodiment includes twelve cavities in each plate. Also heating elements 800 and 810 are located behind each plate as seen in FIG. 8.

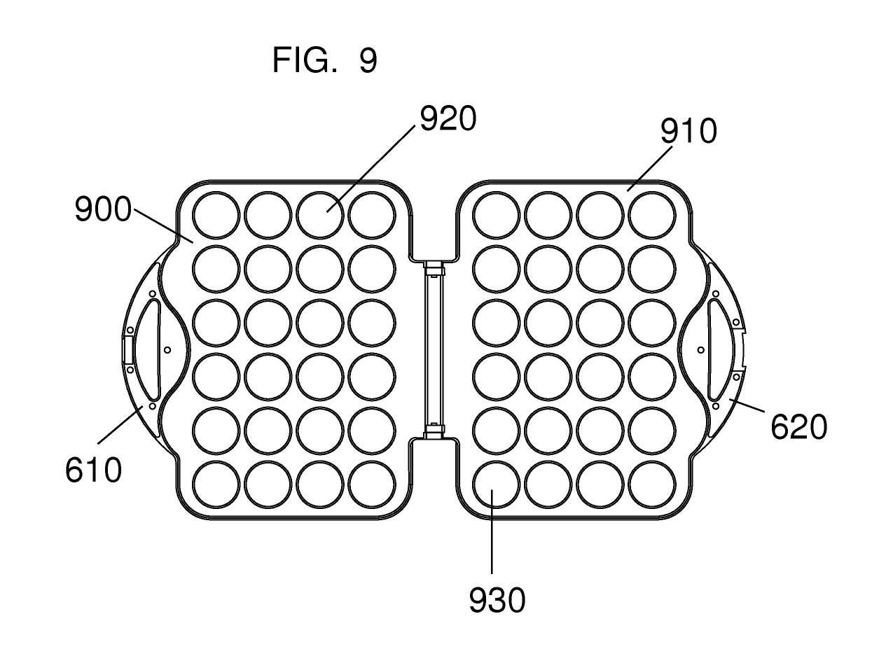

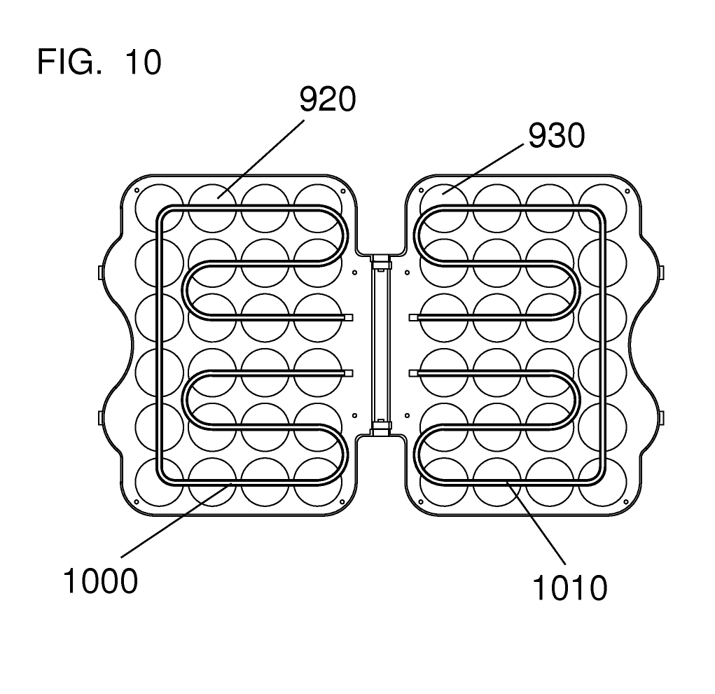

In one embodiment the covers 610 and 620 of cooking apparatus 700 have plates 900 and 910 which in turn present several cavities in a substantially hemispherical shape 920 and 930. The cooking apparatus in this embodiment includes twenty-four cavities in each plate, as seen in FIG. 9 and FIG. 10. Also heating elements 1000 and 1010 are located behind each plate, as seen in FIG. 10.

This invention has been described in various embodiments; however, it will be apparent to those skilled persons in the art, that various changes and modifications thereof can be made without departing from the scope of the following claims.

1. A cooking apparatus, comprising a first cover and a second cover, each cover with heating elements, the first cover and second cover are hinged together to contact each other, wherein each of the covers includes a plate having at least one cavity in a substantially hemispherical shape to receive a food product for cooking, the at least one cavity in a substantially hemispherical shape in the first plate matches the at least one cavity of the second plate to contact both covers; the heating element of each cover is arranged such that said heating element is in contact with substantially a center of the at least one cavity of each plate in a substantially hemispherical shape.

2. The cooking apparatus of claim 1, wherein each plate includes six cavities in a substantially hemispherical shape.

3. The cooking apparatus of claim 1, wherein each plate includes twelve cavities in a substantially hemispherical shape.

4. The cooking apparatus of claim 1, wherein each plate includes twenty cavities in a substantially hemispherical shape.
